(19) United States
(12) Patent Application Publication
(10) Pub. No.: US 2010/0243945 A1
(43) Pub. Date: Sep. 30, 2010

(54) SOFT MAGNETIC CORE AND MANUFACTURING METHOD THEREOF

(75) Inventors: Seigo TOKORO, Tokyo (JP); Kouyuu ENDA, Tokyo (JP)

Correspondence Address: OLIFF & BERRIDGE, PLC, P.O. BOX 320850, ALEXANDRIA, VA, 22320-4850, US

(73) Assignee: TDK CORPORATION, TOKYO (JP)

(21) Appl. No.: 12/707,274

(22) Filed: Feb. 17, 2010

(30) Foreign Application Priority Data
Mar. 25, 2009 (JP) 2009-075134

(51) Int. Cl. H01F 1/00

(52) U.S. Cl. 252/62.51 R

(57) ABSTRACT

A soft magnetic core including a soft magnetic material and a low melting point lubricant is manufactured by adding a low melting point lubricant into an insulation-treated soft magnetic material, warm forming the soft magnetic material with the low melting point lubricant added, and performing a thermal treatment on the warm-molded soft magnetic material. The low melting point lubricant has a melting point ranging from 50° C. to 170° C., and includes at least a material selected from the group consisting of zinc oleate, copper stearate, zinc stearate, calcium stearate, and aluminum stearate.

### CROSS-REFERENCE TO RELATED APPLICATIONS

This application is based upon and claims the benefit of priority from Japanese Patent Application No. 2009-075134, filed Mar. 25, 2009, the entire contents of which are incorporated herein by reference.

### BACKGROUND OF THE INVENTION

1. Field of the Invention

The present invention relates to a soft magnetic core and a manufacturing method thereof.

2. Description of the Related Art

A dust core has been used as a magnetic core employed in an inductance element. The dust core is a soft magnetic core made from a soft magnetic material. Basic factors for evaluating performance of a soft magnetic core include density [g/cm³], core loss (corresponding to loss of a magnetic core of a dust core), and 1T magnetic field (e.g., a magnetic field H [A/m] to obtain a magnetic flux density of 1 T (B=1 [T])). Accordingly, dust cores having high density, low core loss, and low 1T magnetic field exhibit good performance. In general, a soft magnetic core is manufactured by warm forming so as to have a higher density and reduce the 1T magnetic field. Also, a soft magnetic core is produced with a powder, which is an agglomerate of particles (dust) having an insulation-treated (e.g., phosphoric acid-treated) iron as a main component for the purpose of reducing core loss and enhancing an insulating property. In addition, a soft magnetic core is made from a soft magnetic material to which a lubricant is added, so as to attain higher density and accelerate deformation of the soft magnetic material during the warm forming. In the manufacture of the soft magnetic core, a metal soap is used as the lubricant. Although the metal soap has various types, lithium stearate disclosed in Japanese Patent Application Laid-open No. 2006-183121 is generally used to manufacture the soft magnetic core.

In addition to being added to the soft magnetic material, the lubricant may be used so as to enhance mold releasability of the soft magnetic core. For example, Japanese Patent Application Laid-open No. 2005-072112 discloses that the mold releasability of the soft magnetic core may be enhanced by previously coating zinc stearate or lithium stearate on the mold.

However, since there are ongoing demands for further higher density, reduction of core loss and reduction of 1T magnetic field in the soft magnetic core, a soft magnetic core having performance better than a conventional soft magnetic core is required. Accordingly, the inventors have studied in detail lubricants used in manufacturing soft magnetic cores. As a result, it has been found that lithium stearate and beryllium stearate, which are metal soaps generally used as lubricants, have a high melting point, thereby not increasing a warm mold temperature up to the melting point or requiring a time for increasing the warm mold temperature up to the melting point, and thus such metal soaps are not sufficiently introduced between soft magnetic materials during a warm forming. Therefore, the foregoing lubricants having a high melting point make the flowability of a soft magnetic material insufficient during the warm forming, and thus make it insufficient to accelerate deformation of the soft magnetic material by a pressure and make it difficult to provide a dust core with a sufficiently high density.

Also, it has been found that if the lubricant, which is added into the soft magnetic material and has the insulating property, is introduced between the soft magnetic materials, the lubricant functions as an insulation layer interposed between the particles of the soft magnetic material and the insulating property between the soft magnetic materials is enhanced. Thus, since such lubricants having a high melting point are insufficiently introduced between the soft magnetic materials during the warm forming, i.e., since, though the lubricants have the insulating property, the lubricants may not be sufficiently interposed as an insulation layer between the soft magnetic materials, electrical resistance is not high, loss of eddy current is not reduced, and the core loss is not reduced.

### SUMMARY OF THE INVENTION

A soft magnetic core according to an aspect of the present invention includes a soft magnetic material and a low melting point lubricant, the soft magnetic core having a relative density of 97.2% or more with respect to the soft magnetic material.

A method of manufacturing a soft magnetic core according to another aspect of the present invention includes adding a low melting point lubricant into a soft magnetic material; and warm forming the soft magnetic material with the low melting point lubricant added.

The above and other objects, features, advantages and technical and industrial significance of this invention will be better understood by reading the following detailed description of presently preferred embodiments of the invention, when considered in connection with the accompanying drawings.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

### BRIEF DESCRIPTION OF THE DRAWINGS

FIG. 1 is a schematic view illustrating a relationship between a soft magnetic material and a low melting point lubricant during a warm forming according to the invention;

FIG. 2 is a schematic view illustrating a relationship between a soft magnetic material and a high melting point lubricant in a warm forming according to the related art;

FIG. 3 is a flowchart illustrating a method of manufacturing a soft magnetic core; and

FIG. 4 is a graph illustrating a relationship between a relative density of a soft magnetic core and a mold temperature.

### DETAILED DESCRIPTION OF THE PREFERRED EMBODIMENTS

Exemplary embodiments according to the present invention will now be described in detail with reference to the accompanying drawings. Further, the present invention is not limited by the embodiments. Also, elements in the following embodiments include equivalents thereof, for example, elements easily deduced by a person having ordinary skill in the art, and elements substantially identical thereto.

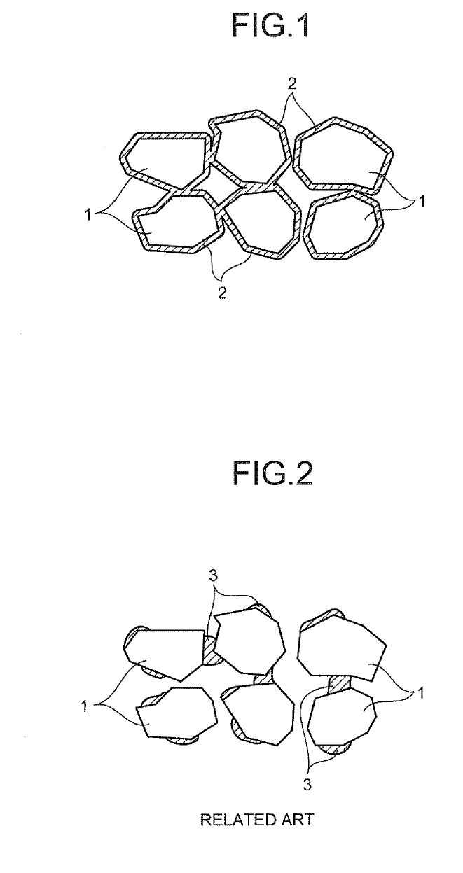

A soft magnetic core according to the invention is manufactured by adding a low melting point lubricant to at least soft magnetic material, and by conducting warm forming of the soft magnetic material with the low melting point lubricant added. Here, the warm forming of the soft magnetic material includes simultaneously warming and pressing the soft magnetic material with the low melting point lubricant added at a temperature higher than a room temperature to thereby form the soft magnetic material into a predetermined shape. That is, the soft magnetic core according to the invention includes a soft magnetic material and a low melting point lubricant. FIG. 1 is a schematic view illustrating a relationship between a soft magnetic material and a low melting point lubricant during the warm forming according to the invention. FIG. 2 is a schematic view illustrating a relationship between a soft magnetic material and a high melting point lubricant during the warm forming according to the related art. In FIGS. 1 and 2, reference numeral 1 denotes a soft magnetic material, reference numeral 2 denotes a low melting point lubricant, and reference numeral 3 denotes a high melting point lubricant. The high melting point lubricant 3 generally indicates lubricants having a melting point higher than 170° C., for example, beryllium stearate (hereinafter, may be simply referred to as “St—Be”) having a melting point of 180° C., lithium stearate (hereinafter, may be simply referred to as “St—Li”) having a melting point of 220° C.

The soft magnetic material 1 includes a soft magnetic core as a main component. The main component of the soft magnetic material 1 is iron, which includes pure iron and iron containing an unavoidable impurities. Examples of the soft magnetic material 1 include iron, a composition in which an element (e.g., Si, P, Co, Ni Cr, Al, Mo, Mn, Cu, Sn, Zr, B, V, Zn, etc.) is actively added to iron, permalloy, sendust, and combinations thereof. The soft magnetic material 1 is composed of particles or dusts, and these are aggregated to form a powder of the soft magnetic material 1. That is, the soft magnetic material 1 is made of an iron-base powder that is a particle (dust) containing iron as a main component. Also, a particle size of the iron-base powder has an effect on a relative density with respect to the soft magnetic material 1 to be described later (hereinafter, may be simply referred to as “relative density”) and on magnetic field of 1T. If the particle size is small, the soft magnetic material 1 is rarely deformed by pressure during the warm forming. Therefore, a small particle size is not preferred, and, for example, it is preferable that an average particle size be about 200 μm. The soft magnetic material 1 may be obtained by already-known adjustment methods such as a gas atomizing method, a water atomizing method, a spin atomizing method, and a cast milling method.

The low melting point lubricant 2 does not only secure the flowability of the soft magnetic material 1, but also functions as an insulation layer interposed between the soft magnetic materials 1. The low melting point lubricant 2 is a lubricant used in manufacture of the soft magnetic core, which has an insulating property and a low melting point. Here, the low melting point means that the melting point ranges from 50° C. to 170° C. That is, the low melting point lubricant 2 is a lubricant having a melting point ranging from 50° C. to 170° C. The lubricant having a melting point ranging from 50° C. to 170° C. may include zinc oleate (hereinafter, may be simply referred to as “Ore-Zn”) having a melting point of 78° C., copper stearate (hereinafter, may be simply referred to as “St—Cu”) having a melting point of 125° C., zinc stearate (hereinafter, may be simply referred to as “St—Zn”) having a melting point of 127° C., calcium stearate (hereinafter, may be simply referred to as “St—Ca”) having a melting point of 150° C., aluminum stearate (hereinafter, may be simply referred to as “St—Al”) having a melting point of 160° C., and combinations thereof. The melting point of the low melting point lubricant 2 should be 50° C. or higher for the following reasons. First, a lubricant having a melting point less than 50° C. may be transformed into an intermediate phase from a solid phase at a room temperature, which will be described later. The lubricant may not widely spread uniformly over the soft magnetic material 1 when the soft magnetic material 1 is added, and the lubricant may be susceptible to be adhered to a forming mold during a warm forming. The forming may also be difficult due to an increase in a discharge pressure (pressure for releasing the soft magnetic material 1 (soft magnetic core) from the forming mold after the warm forming). The reason why the melting point of the low melting point lubricant 2 should be 170° C. or lower is that, during warm forming, a lubricant having a melting point exceeding 170° C. is not sufficiently transformed into an intermediate phase from a solid phase and the lubricant may not be introduced between the soft magnetic materials 1, which will be described later. A lubricant having a low melting point is suitable for the low melting point lubricant 2, and zinc oleate of lubricants having a melting point ranging from 50° C. to 170° C. is very suitable for the low melting point lubricant.

Here, the following description will be made on the relationship between the soft magnetic material 1 and the lubricant during the warm forming. As stated above, during the warm forming, the soft magnetic material 1, into which the lubricant is added, is pressed while being warmed at a temperature higher than a room temperature. Accordingly, since the temperature of the lubricant added into the soft magnetic material 1 gets close to the melting point during the warm forming, the lubricant 2 changes its form. Specifically, the lubricant may maintain an orderly-layered crystal structure at a temperature lower than the melting point by 50° C. or more, however, when the temperature becomes a temperature lower than the melting point by 30° C. or less, the lubricant may be changed into a disc shape with a size in which the occurrence of looseness in the orderly-layered crystal structure is limited. That is, as the temperature rises up to the melting point, the phase of the lubricant is transformed, from a solid phase, into an intermediate phase which is between the solid phase and the liquid phase. When the temperature reaches the melting point or higher, the phase of the lubricant is finally transformed into a liquid phase. Hence, as the temperature becomes close to the melting point, the flowability of the lubricant may be enhanced, and the lubricant may be introduced between the soft magnetic materials 1.

Since the high melting point lubricant 3 having a melting point higher than the low melting point lubricant 2 has a large temperature difference between a mold temperature (temperature of a forming mold (not shown) into which the soft magnetic material 1 with the lubricant added is filled) in the warm forming and the melting point, the high melting point lubricant 3 may not be sufficiently transformed from a solid phase into an intermediate phase. Therefore, as illustrated in FIG. 2, during the warm forming of the soft magnetic material 1 into which the high melting point lubricant 3 is added, the flowability of the high melting point lubricant 3 is not enhanced, may not be sufficiently introduced between the soft magnetic materials 1, and may not sufficiently surround the periphery of an iron-base powder. Hence, the lubrication between iron-base powders may not be enhanced during the warm forming of the soft magnetic material 1 with the high melting point lubricant 3 added, and thus it may be difficult to sufficiently secure the flowability of the soft magnetic material 1. Accordingly, the soft magnetic core including the soft magnetic material 1 and the high melting point lubricant 3 may not accelerate the deformation of the soft magnetic material 1 by pressure during the warm forming, and may not achieve high density sufficiently. Also, during the warm forming of the soft magnetic material 1 with the high melting point lubricant 3 added, as described above, since the high melting point lubricant 3 having the insulating property may not sufficiently surround the periphery of the iron-base powder, the high melting point lubricant may not be sufficiently interposed between the soft magnetic materials 1 as an insulation layer even though the high melting point lubricant 3 has the insulating property. Accordingly, the soft magnetic core including the soft magnetic material 1 and the high melting point lubricant 3 may not enhance the insulating property.

On the other hand, since the low melting point lubricant 2 having a melting point lower than the high melting point lubricant 3 has a small temperature difference between the mold temperature in the warm forming and the melting point, the low melting point lubricant 2 may be sufficiently transformed from a solid phase into an intermediate phase. Particularly, in comparison with the high melting point lubricant 3, the low melting point lubricant 2 may be transformed from a solid phase to an intermediate phase before the soft magnetic core with the low melting point lubricant 2 added is formed into an arbitrary shape because, at an initial stage of the warm forming, the lubrication between iron-base powders by pressure during the warm forming reduces a clearance of the iron-base powder and the iron-base powder is also deformed by pressure. Therefore, as illustrated in FIG. 1, particularly at the initial stage of the warm forming of the soft magnetic material 1 into which the low melting point lubricant 2 is added, the low melting point lubricant 2 may enhance the flowability, may be sufficiently introduced between the soft magnetic materials 1, and may surround the periphery of the iron-base powder sufficiently. Since this may enhance the lubrication between the iron-base powders during the warm forming of the soft magnetic material 1 with the low melting point lubricant 2 added, the flowability of the soft magnetic material 1 may be sufficiently guaranteed. Accordingly, the soft magnetic core, which includes the soft magnetic material 1 and the low melting point lubricant 2, may accelerate the deformation of the soft magnetic material 1 by pressure during the warm forming, have a density that is close to a theoretical density of the soft magnetic material, i.e., a real density, and sufficiently attain higher density. Since higher density may be sufficiently attained, 1T magnetic field (e.g., a magnetic field H [A/m] when the magnetic flux density is 1 T (B=1 [T])) may be sufficiently reduced. Moreover, as described above, during the warm forming of the soft magnetic material 1 with the low melting point lubricant 2 added, the low melting point lubricant 2 having the insulating property may surround the iron-base powder sufficiently, and therefore the low melting point lubricant 2 may be interposed between the soft magnetic materials 1 sufficiently as an insulation layer. Hence, the soft magnetic core including the soft magnetic material 1 and the low melting point lubricant 2 may enhances the insulating property, and reduce core loss (in the case of dust core, loss of a magnetic core).

Before the low melting point lubricant 2 is added to the soft magnetic material 1, the soft magnetic material 1 is insulation-treated. Once the soft magnetic material 1 is insulation-treated, an insulation layer surrounding the periphery of the iron-base powder is formed, thereby enhancing insulating properties. However, the insulation layer surrounding the periphery of the iron-base powder may be cleaved due to the deformation of the soft magnetic material 1 that is insulation-treated by pressure during the warm forming, and resultantly the surface of the iron-base powder itself may be exposed. However, as described above, the low melting point lubricant 2 may be sufficiently introduced between the soft magnetic materials 1 and surround the periphery of the iron-base lubricant. Thus, the insulating properties of the insulation-treated soft magnetic material 1 may be maintained because the low melting point lubricant 2 is interposed between the soft magnetic materials 1 as an insulation layer sufficiently even if the insulation layer surrounding the periphery of the iron-base powder is deteriorated.

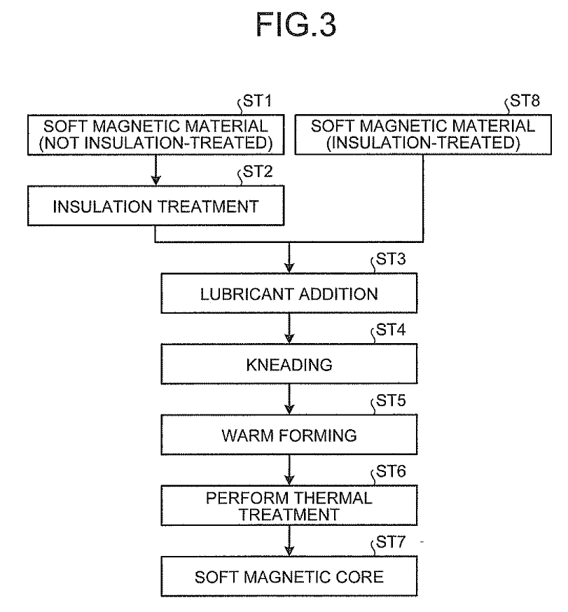

Next, a method of manufacturing a soft magnetic core according to the invention will be described below. As described above, the soft magnetic core is manufactured by adding the low melting point lubricant 2 to at least the soft magnetic material 1, and warm forming the soft magnetic material 1 into which the low melting point lubricant 2 is added. FIG. 3 is a flowchart illustrating a method of manufacturing a soft magnetic core. In an exemplary embodiment, as illustrated in FIG. 3, in a case where a soft magnetic core (step ST7) according to the invention is manufactured with the soft magnetic material 1 (step ST1) that is not insulation-treated, the method of manufacturing the soft magnetic core includes: performing an insulation treatment on the soft magnetic material 1 that is not insulation-treated (step ST2); adding the low melting point lubricant 2 into the insulation-treated soft magnetic material 1 (step ST3); kneading the soft magnetic material 1 with the low melting point lubricant 2 added (step ST4); warm forming the kneaded soft magnetic material 1 (step ST5); and performing a thermal treatment on the warm-molded soft magnetic material 1 (step ST6). In a case where a soft magnetic core (step ST7) according to the invention is manufactured with the soft magnetic material 1 (step ST8) that has already been insulation-treated, the method of manufacturing the soft magnetic core includes: adding the low melting point lubricant 2 into the insulation-treated soft magnetic material 1 (step ST3); kneading the soft magnetic material 1 with the low melting point lubricant 2 added (step ST4); warm forming the kneaded soft magnetic material 1 (step ST5); and performing a thermal treatment on the warm-molded soft magnetic material 1 (step ST6).

Each process will be described hereinbelow.

In the process (step ST2) of performing insulation treatment on the soft magnetic material 1 that is not insulation-treated, the soft magnetic material 1 is insulation-treated in advance prior to addition of the low melting point lubricant 2, and an insulation layer surrounding the periphery of an iron-base powder is formed. The insulation treatment may be, for example, phosphoric acid treatment. The phosphoric acid-treatment is performed in such a way that the soft magnetic material 1 is treated with an aqueous solution including a phosphoric acid and a phosphate as main constituents, and a phosphate film is formed around the iron-base powder. After insulation treatment by aqueous solution, e.g., phosphoric acid-treatment, the soft magnetic material 1 is dried prior to addition of the low melting point lubricant 2. As an example of a drying method, the soft magnetic material 1 that has undergone the phosphoric acid-treatment is dried in a hot plate at 70° C. Accordingly, the soft magnetic material 1 is insulation-treated so that an insulation layer surrounding the periphery of the iron-base powder is formed, and is interposed between the iron-base powders, and resultantly the insulating property of the soft magnetic core may be enhanced.

In the process (step ST3) of adding the low melting point lubricant 2 into the soft magnetic material 1 that underwent the insulation treatment or has already been insulation-treated, a predetermined amount of the low melting point lubricant is added to the soft magnetic material 1. Here, the low melting point lubricant 2 added to the soft magnetic material 1 may include a metal soap including a melting point ranging from 50° C. to 170° C. The metal soap including a melting point ranging from 50° C. to 170° C. may include zinc oleate, copper stearate, zinc stearate, calcium stearate, aluminum stearate, and combinations thereof. The predetermined amount is in the range of 0.02 wt % to 0.2 wt %, preferably 0.1 wt %. The reason why the predetermined amount should be 0.02 wt % or more is that, if the predetermined amount is less than 0.02 wt %, the amount of the low melting point lubricant 2 is too small with respect to the soft magnetic material 1 so that the low melting point lubricant 2 may not uniformly spread widely over the soft magnetic material 1 even with the addition of the low melting point lubricant 2 into the soft magnetic material 1. Also, the reason why the predetermined amount should be 0.2 wt % or less is that, if the predetermined amount exceeds 0.2 wt %, the effect of adding the low melting point lubricant 2 is saturated and also higher density and reduction in magnetic field of 1T may not be attained due to a decrease in the amount of the soft magnetic material 1 of the soft magnetic core.

In the process (step ST4) of kneading the soft magnetic material 1 with the low melting point lubricant 2 added, the soft magnetic material 1 and the low melting point lubricant 2 are mixed in order that the added low melting point lubricant 2 may uniformly spread over the soft magnetic material 1 widely. The kneading process is performed using a mixer (e.g., attritor, vibration mill, ball mill, V mixer, etc.) or a granulator (e.g., flowing granulator, tumbling granulator, etc.).

In the process (step ST5) of warm forming the kneaded soft magnetic material 1, the soft magnetic material 1 with the low melting point lubricant 2 added is simultaneously warmed and pressed at a temperature higher than a room temperature, thereby forming the soft magnetic material 1 into an arbitrary shape. The warm forming is performed in such a way that the soft magnetic material with the low melting point lubricant 2 added is filled into a forming mold including a cavity of an arbitrary shape, the forming mold is then heated up to a mold temperature, and the soft magnetic material 1 with the low melting point lubricant 2 added is compressively formed under a molding pressure corresponding to a pressure required for compressing the filled soft magnetic material 1. The mold temperature is in the range of 80° C. to 200° C., preferably 130° C. Here, the reason why the mold temperature should be 80° C. or higher is that, if the mold temperature is less than 80° C., the low melting point lubricant 2 may not be sufficiently transformed from a solid phase into an intermediate phase, and from the intermediate phase to a liquid phase, the low melting point lubricant 2 is not sufficiently introduced between the soft magnetic materials 1, and higher density and reduction in 1T magnetic field may not be attained, because the mold temperature is much lower than the melting point of the low melting point lubricant 2. The reason why the mold temperature should be 200° C. or lower is that, if the mold temperature is beyond 200° C., oxidation of the soft magnetic material 1 may be accelerated, properties of the soft magnetic material 1 may be degraded in warm forming, and manufacturing cost may be increased due to an increase in energy required for warming the forming mold. The molding pressure is in the range of 6 ton/cm² to 12 ton/cm², preferable 10 ton/cm². Here, the reason why the molding pressure should be 6 ton/cm² or more is that, if the molding pressure is less than 6 ton/cm², it is difficult to attain higher density and reduce magnetic field of 1T through the warm forming. The reason why the molding pressure is 12 ton/cm² or less is that, if the molding pressure is beyond 12 ton/cm², manufacturing cost may be increased due to an increase in energy required for pressurizing the soft magnetic material 1 with the low melting point lubricant 2 added, the deterioration of the forming mold may be in progress, and the durability of the forming mold may be degraded, in addition to the saturation of the effect.

The process (step ST6) of performing the thermal treatment on the warm-formed soft magnetic material 1 releases strain in an iron-base powder due to pressurization in the warm forming, and reduces core loss (particularly, hysteresis loss). The thermal treatment may be, for example, an annealing treatment. The annealing treatment is a process of heating, in an annealing furnace, the soft magnetic material 1 that has been formed into a predetermined shape through the warm forming. An ambient of the annealing furnace may be any one of atmospheric ambient, low-oxygen ambient using argon or nitrogen, hydrogen ambient, carbon gas ambient, and vacuum ambient.

The present invention is more fully described by the following example, but not limited to the example.

Any one of lubricants including zinc oleate, copper stearate, zinc stearate, calcium stearate, aluminum stearate, beryllium stearate, and lithium stearate is added in an amount of 0.1 wt % into a soft magnetic material (trade name: Somaloy700, manufactured by Hoeganaes, Inc.) that has already been insulation-treated. Then, the soft magnetic material with the lubricant added is put into a mixer (trade name: V mixer, manufactured by Tsutsui Scientific Instruments CO., Ltd.), and kneaded at a rotation number of 12 rpm for 10 minutes. Thereafter, the kneaded soft magnetic material is warm-folded under conditions such as a mold temperature of 130° C. and a molding pressure of about 980 MPa (10 ton/cm²). The warm-folded soft magnetic material is loaded into an annealing furnace, and a temperature is then increased up to 550° C. at 5° C./min (in low-oxygen ambient until 160° C., and atmospheric ambient beyond 160° C.). Afterwards, the temperature of the annealing furnace is maintained at 550° C. for 1 hour, thereby manufacturing a soft magnetic core including a soft magnetic material and a low melting point lubricant (selected from the group consisting of Ore-Zn, St—Cu, St—Zn, St—Ca, and St—Al), and a soft magnetic core including a soft magnetic material and a high melting point lubricant (selected from the group consisting of St—Be and St—Li).

A relative density (%) of the soft magnetic core prepared through the above-described method with respect to the soft magnetic material (iron (density: 7.87 [g/cm³]) in this example) was measured. Also, core loss (W/g) at 1 KHz (using a measuring apparatus (trade name: E5060A, manufactured by Hewlett Packard)) and 1T magnetic field (A/m) of the soft magnetic core were measured. Measurement results are shown in Table 1.

TABLE 1

| | | | Core | | |
|---|---|---|---|---|---|
| | | Mold | loss | 1T | |
| | Melting | temper- | [W/g] | magnetic | Relative |
| | point | ature | at 1 | field | density |
| Lubricant | [° C.] | [° C.] | kHz | [A/m] | [%] |
| St-Al | 160 | 130 | 135 | 1230 | 97.71 |
| St-Zn | 127 | 130 | 113 | 1132 | 98.22 |
| St-Ca | 150 | 130 | 155 | 1145 | 97.97 |
| St-Cu | 125 | 130 | 129 | 1215 | 97.84 |
| St-Li | 220 | 130 | 200 | 1276 | 97.08 |
| St-Be | 180 | 130 | 180 | 1310 | 96.70 |
| Ore-Zn | 78 | 130 | 101 | 1163 | 97.97 |

From Table 1, it is confirmed that the soft magnetic core including the soft magnetic material and the low melting point lubricant has the relative density of 97.2 or more (Ore-Zn=97.97, St—Cu=97.84, St—Zn=98.22, St—Ca=97.97, St—Al=97.71), and attains higher density, compared to the soft magnetic core including the soft magnetic material and the high melting point lubricant having the relative density below 97.2 (St—Be=96.70, St—Li=97.08). Also, it is confirmed that the soft magnetic core including the soft magnetic material and the low melting point lubricant has the core loss of 160 or less (Ore-Zn=101, St—Cu=129, St—Zn=113, St—Ca=155, St—Al=135), and reduces the core loss and enhances the insulating property, compared to the soft magnetic core including the soft magnetic material and the high melting point lubricant having the core loss exceeding 160 (St—Be=180, St—Li=200). Also, it is confirmed that the soft magnetic core including the soft magnetic material and the low melting point lubricant has the magnetic field of 1T of 1250 or less (Ore-Zn=1163, St—Cu=1215, St—Zn=1132, St—Ca=1145, St—Al=1230), and reduces the 1T magnetic field, compared to the soft magnetic core including the soft magnetic material and the high melting point lubricant having the 1T magnetic field exceeding 1250 (St—Be=1310, St—Li=1276). From these results, it is confirmed that the soft magnetic core including the soft magnetic material and the low melting point lubricant attains both high density and enhancement of the insulating property, and realizes high densification, reduction in core loss and reduction in 1T magnetic field, compared to the soft magnetic core including the soft magnetic material and the high melting point lubricant.

Afterwards, the soft magnetic cores each including the soft magnetic material and the low melting point lubricant (selected from the group consisting of Ore-Zn, St—Cu, St—Zn, St—Ca, and St—Al), and the soft magnetic cores each including the soft magnetic material and the high melting point lubricant (selected from the group consisting of St—Be and St—Li) are prepared at the mold temperature of 25° C., 80° C., 130° C., 150° C., and 200° C., respectively.

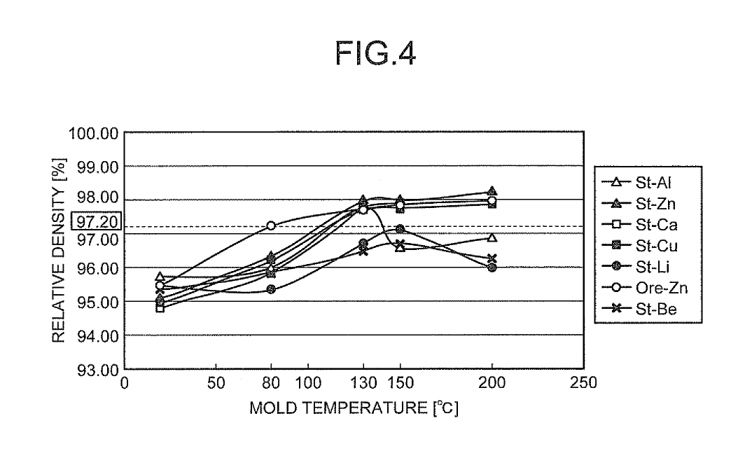

Relative densities [%] of the prepared soft magnetic cores with respect to the soft magnetic materials (iron (density: 7.87 [g/cm³]) in this example) were measured, which are shown in FIG. 4. As shown in FIG. 4, in a case of the high melting point lubricant, i.e., St—Be and St—Li, the soft magnetic core is difficult to attain the relative density of 97.2 or more between a room temperature and 200° C. At a room temperature, even in a case of the low melting point lubricant, i.e., Ore-Zn, St—Cu, St—Zn, St—Ca, and St—Al, the soft magnetic core is difficult to attain the relative density of 97.2 or more. That is, it is confirmed that the soft magnetic core including the soft magnetic material and the high melting point lubricant may not attain high density sufficiently, and reduce 1T magnetic field sufficiently even if the mold temperature varies. Likewise, it is confirmed that, when the mold temperature is a room temperature, the soft magnetic core including the soft magnetic material and the low melting point lubricant may not attain higher density sufficiently, and may not realize high densification and reduction in 1T magnetic field sufficiently.

As described above, in a case of the low melting point lubricant, i.e., Ore-Zn, St—Cu, St—Zn, St—Ca, and St—Al, the relative density of the soft magnetic core may be 97.2 or more at the mold temperature of 130° C. Also, as described above, in a case of the low melting point lubricant, i.e., Ore-Zn, St—Cu, St—Zn and St—Ca, the relative density of the soft magnetic core may be 97.2 or more at the mold temperature between 130° C. and 200° C. Moreover, in a case where the low melting point lubricant is Ore-Zn, the relative density may be 97.2 or more at the mold temperature even between 80° C. and 200° C. That is, it is confirmed that the soft magnetic core including the soft magnetic material and the low melting point lubricant may attain higher density in a broad range of mold temperature sufficiently, and may realize high densification and reduction in 1T magnetic field sufficiently, compared to the soft magnetic core including the soft magnetic material and the high melting point lubricant. In particular, it is confirmed that the low melting point lubricant of Ore-Zn may sufficiently attain higher density through the warm forming even at a low temperature of 80° C., and may achieve high densification and reduction in 1T magnetic field sufficiently.

Thereafter, the soft magnetic cores each including the soft magnetic material and the low melting point lubricant (selected from the group consisting of Ore-Zn, St—Cu, St—Zn, St—Ca, and St—Al), and the soft magnetic cores each including the soft magnetic material and the high melting point lubricant (selected from the group consisting of St—Li and St—Be) are prepared at the mold temperature of 25° C., 130° C., 150° C., and 200° C., respectively.

Relative densities [%] of the prepared soft magnetic cores prepared through the above-described method with respect to the soft magnetic materials (iron (density: 7.87 [g/cm³]) in this example) were measured, and also core losses and 1T magnetic fields of the soft magnetic cores were measured. The measurement results are shown in Table 2. Here, when the relative density is 97.2 or more, it is symbolized by “A”; and when the relative density is 97.2 or less, it is symbolized by “C”. When the core loss is 120 or less, it is symbolized by “A”; when the core loss exceeds 120 but not more than 160, it is symbolized by “B”; and, when the core loss exceeds 160, it is symbolized by “C”. When the 1T magnetic field is 1200 or less, it is symbolized by “A”; when the 1T magnetic field exceeds 1200 but not more than 1250, it is symbolized by “B”; and, when the 1T magnetic field exceeds 1250, it is symbolized by “C”. If the relative density, core loss, 1T magnetic field do not belong to the range “C”, such soft magnetic cores may attain both of higher density and enhancement of the insulating property, and may also realize high densification, reduction in core loss, and reduction in 1T magnetic field of.

TABLE 2

| | Mold | | 1T | |
|---|---|---|---|---|
| | temperature | Core | magnetic | |
| Lubricant | [° C.] | loss | field | Density |
| St-Al | 25 | B | C | C |
| | 130 | B | B | A |
| | 150 | B | C | C |
| | 200 | C | A | C |
| St-Zn | 25 | B | C | C |
| | 130 | A | A | A |
| | 150 | C | A | A |
| | 200 | C | A | A |
| St-Ca | 25 | C | C | C |
| | 130 | B | A | A |
| | 150 | C | A | A |
| | 200 | B | B | A |
| St-Cu | 25 | B | C | C |
| | 130 | B | B | A |
| | 150 | B | A | A |
| | 200 | B | C | A |
| St-Li | 25 | C | C | C |
| | 130 | C | C | C |
| | 150 | C | C | C |
| | 200 | C | C | C |
| St-Be | 25 | C | C | C |
| | 130 | C | C | C |
| | 150 | C | C | C |
| | 200 | C | C | C |
| Ore-Zn | 25 | B | C | C |
| | 130 | A | A | A |
| | 150 | A | A | A |
| | 200 | A | A | A |

From Table 2, it is confirmed that, in a compression molding at a room temperature, the soft magnetic core including the soft magnetic material and the low melting point lubricant may reduce the core loss to 160 or less according to a type of the low melting point lubricant, however, does not increase the relative density to 97.2 or more and does not reduce the 1T magnetic field to 1250 or less. That is, it is confirmed that, in the compression molding at a room temperature, both of higher density and the insulating property are not sufficiently attained, and high densification, reduction in core loss, and reduction in 1T magnetic field may not be sufficiently achieved. In the soft magnetic core including the soft magnetic material and the high melting point lubricant, it is confirmed that, even if the mold temperature varies, the relative density may not be increased to 97.2 or more, the core loss may not be reduced to 160 or less, and the 1T magnetic field may not be reduced to 1250 or less. That is, it is confirmed that both of higher density and enhancement of the insulating property are not sufficiently attained, and high densification, reduction in core loss, and reduction in 1T magnetic field may not be sufficiently realized, in the soft magnetic core including the soft magnetic material and the high melting point lubricant.

Meanwhile, from Table 2, it is confirmed that the soft magnetic core including the soft magnetic material and the low melting point lubricant may increase the relative density to 97.2 or more, reduce the core loss to 160 or less, and reduce the 1T magnetic field to 1250 or less according to a type of the low melting point lubricant, by varying the mold temperature. For example, in the low melting point lubricant of St—Ca, it is confirmed that, at the mold temperature of 130° C., the relative density may be increased to 97.2 or more, the core loss may be reduced to 160 or less, and the 1T magnetic field may be reduced to 1200 or less; and, at the mold temperature of 200° C., the relative density may be increased to 97.2 or more, the core loss may be reduced to 160 or less, and the 1T magnetic field may be reduced to 1250 or less. In the low melting point lubricant of St—Cu, it is confirmed that, at the mold temperature of 130° C., the relative density may be increased to 97.2 or more, the core loss may be reduced to 160 or less, and the 1T magnetic field may be reduced to 1250 or less; and, at the mold temperature of 150° C., the relative density may be increased to 97.2 or more, the core loss may be reduced to 160 or less, and the 1T magnetic field may be reduced to 1250 or less. Especially, in the low melting point lubricant of Ore-Zn, it is confirmed that, even at the mold temperature of 130° C., 150° C., and 200° C., the relative density may be increased to 97.2 or more, the core loss may be reduced to 120 or less, and the 1T magnetic field may be reduced to 1200 or less. As such, it is confirmed that, according to a type of the low melting point lubricant, the soft magnetic core including the soft magnetic material and the low melting point lubricant may attain both of higher density and enhancement of the insulating property, and may also realize high densification, reduction in core loss, and reduction in 1T magnetic field regardless of the mold temperature, compared to the soft magnetic core including the soft magnetic material and the high melting point lubricant.

The soft magnetic core according to the invention is manufactured by adding a low melting point lubricant to a soft magnetic material, and thus the low melting point lubricant may be sufficiently introduced between the soft magnetic materials during warm forming. Accordingly, since the flowability of the soft magnetic material may be enhanced in the warm forming and also the lubricant may be sufficiently interposed as an insulation layer between the soft magnetic materials, the soft magnetic core may be made with a density close to the density of iron, and both higher density and enhancement of the insulating property may be attained.

Also, in the method of manufacturing a soft magnetic core according to the invention, the soft magnetic core is manufactured by using a soft magnetic material to which a low melting point lubricant is added, and thus the low melting point lubricant may be sufficiently introduced between the soft magnetic materials during warm forming. Consequently, the flowability of the soft magnetic material may be enhanced during the warm forming and also the lubricant may be sufficiently interposed as an insulation layer between the soft magnetic materials. Hence, both higher density and enhancement of the insulating property may be attained.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A soft magnetic core comprising a soft magnetic material and a low melting point lubricant, the soft magnetic core having a relative density of 97.2% or more with respect to the soft magnetic material.

2. The soft magnetic core according to claim 1, wherein the low melting point lubricant has a melting point ranging from 50° C. to 170° C.

3. The soft magnetic core according to claim 1, wherein the low melting point lubricant includes at least a material selected from the group consisting of zinc oleate, copper stearate, zinc stearate, calcium stearate, and aluminum stearate.

4. A method of manufacturing a soft magnetic core, comprising:
adding a low melting point lubricant into a soft magnetic material; and
warm forming the soft magnetic material with the low melting point lubricant added.

5. The method according to claim 4, wherein the soft magnetic material is insulation-treated.

6. The method according to claim 4, wherein the low melting point lubricant includes a metal soap having a melting point ranging from 50° C. to 170° C.

7. The method according to claim 6, wherein a mold temperature of the warm forming ranges from 80° C. to 200° C., and the low melting point lubricant has a melting point equal to or less than the mold temperature.

8. The method according to claim 4, wherein the low melting point lubricant includes at least a material selected from the group consisting of zinc oleate, copper stearate, zinc stearate, calcium stearate, and aluminum stearate.
